(19) United States
(12) Patent Application Publication
(10) Pub. No.: US 2004/0104159 A1
(43) Pub. Date: Jun. 3, 2004

(54) Washable, non-disposable ecological filter for lubricant and fuels

(76) Inventors: Julian Terrazas Benavides, Tacuba (MX); J. Cesar Faraon-Chaul Zakka, Tacuba (MX)

Correspondence Address: Maria Erlinda C Sarno, PO Box 1023, Artesia, CA, 90702, US

(21) Appl. No.: 10/381,299

(22) PCT Filed: Jun. 13, 2001
(86) PCT No.: PCT/MX01/00036

(30) Foreign Application Priority Data
Jun. 13, 2000 (MX) 005837

(51) Int. Cl. B01D 29/35; B01D 29/64

(52) U.S. Cl. 210/311; 210/335; 210/342; 210/413

(57) ABSTRACT

A reusable, ecological, long lasting, washable, non disposable filter for lubricant oils and fuels to be used in internal combustion engines or in any other equipment to help prolong the live of the lubricant oils and equipmen One or several essentially cylindrical independent filtering element place one inside the other, each filtering element consisting of a fine stainless steel cloth of a different mesh as needed for an optimal filtration, filtering out large, medium and small particles down to 5 microns if needed. The fin [symbol] stainless steel cloth is enclosed in and retained by an open mesh and a number of rods that forms a cage extending longitudinally between two en [symbol] caps being joint to form an assembly of a single unit by resin caps at each en [symbol] thus forming an independent, leak proof filtering element that keeps the fine stainless steel cloth in position even during cleaning procedure that includes pressurized air that is forced through. The filter comprises a particle removing disc assembly of one or several discs fastened to a concentric shaft extending longitudinally between the two end caps, said discs comprising, bristles at their periphery which are in contact with the roads cage and the fine filtering stainless steel cloth of the inner filtering element, said shaft being rotatable and can be operated from the outside of the filter where cleaning is needed. Special sealing gaskets are provided to avoid any leaks among the parts. By changing the-arrangement of the filtering assemblies the direction of the flow can be changed.

### BACKGROUND OF THE INVENTION

The filters used now for lubricant oils and fuels in internal combustion engines or in any other equipment have a short life span due to the fact that the filtering element that they use gets rapidly saturated with large, medium and small particles and debris that clog the element blocking the fluid flow When used in automotive filtering of lubricants, they must be equipped with a check valve in order to provide a bypass that operates when the filter becomes clogged, this bypass conveys the unfiltered dirty oil back to the motor's crankcase to maintain the flow of lubricant and prevent the motor's collapse.

Due to the materials used in the manufacture of this type of filters, the disposable filtering elements start disintegrating rapidly, thus adding particles of the decaying element to the already dirty oil, resulting all this in costly, permanent damages to the motor.

The filtering elements can't be taken apart, cleaned or washed and in a short period of time they must be discarded, gushing dirty, contaminating lubricating oil or diesel fuel. Once in the waste and during rains, the water entering the discarded filter carries out the polluting fluids that penetrate the ground down trough the sub-soil to the phreatic water deposits, or to the rivers, lakes and oceans, polluting them.

This invention has been developed to eliminate the previously described problems, using a long lasting, sturdy constructed, washable non-disposable and ecologic filter that can be easily disassembled for a complete cleaning that is intended for use with fuels and lubricating oils in internal combustion engines or in any other equipment. Thanks to the design and materials used in it, the disintegration of the filtering elements is avoided and there is the possibility of using one or several filtering elements independent o [symbol] combined placed one inside another directly in the caps inside the filter o [symbol] they can be placed in an stepped or flat base and cap of special design with all the necessary gaskets to provide seals that prevent any leak.

They can be washed and changed and are not easily saturated by impurities due to the fact that each filtrating element has a fine filtering stainless steel cloth of different gage that depends on the size of the particles to be retained, the larger particles are the first to be filtered, followed by those of medium size and down to the smaller ones, obtaining this way an excellent filtration free of the need to discard the filtering elements when they become saturated with debris, contributing this way to prevent the pollution of the environment trough the use of this completely ecological filter.

### INVENTION DESCRIPTION

The novelty of the features of this ecological, washable non-disposable filter for lubricant oils and fuels, to be used in internal combustion engines or any other equipment as well as it's working structure and construction materials, will be better understood with the following description and the four drawings included that are furnished for illustrative but not limitative purposes.

The reference numbers in the figures are used for their identification as follows:

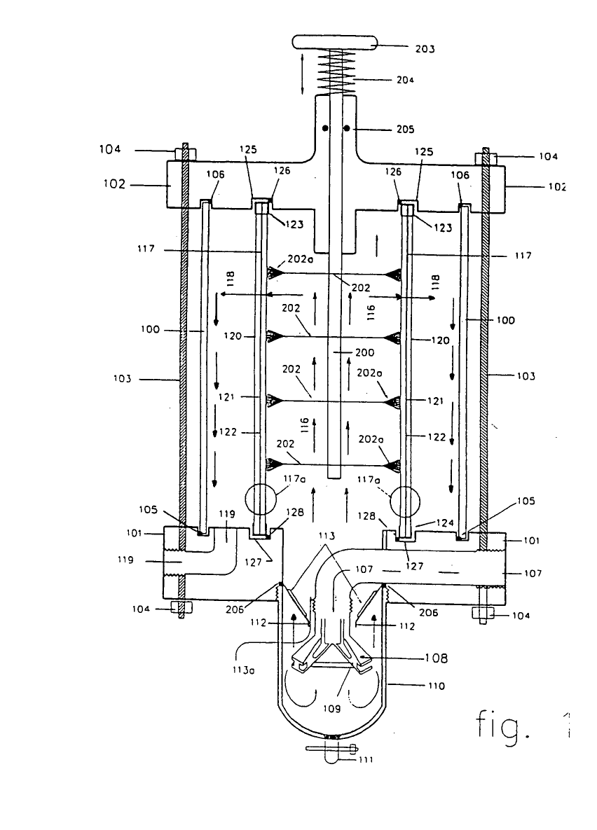

FIG. 1 Shows a front elevation and cross section view of an example of the ecological, washable and non-disposable filter for oils and fuels.

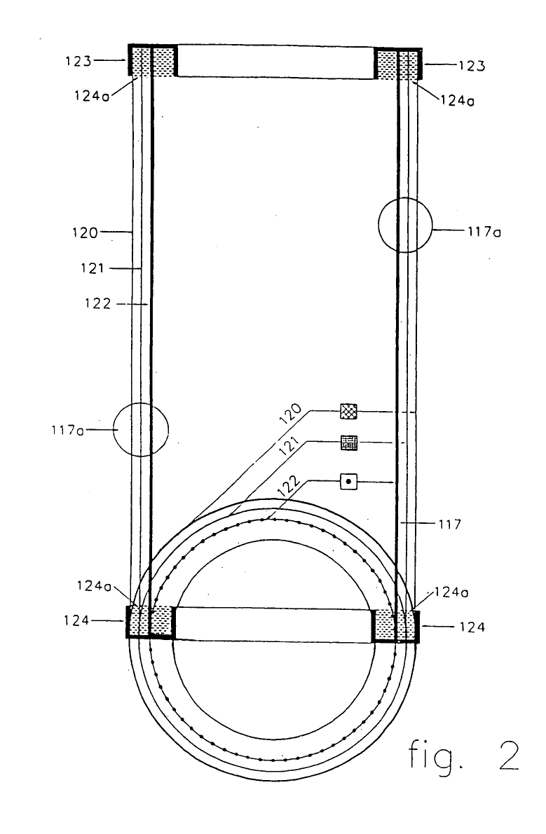

FIG. 2 Shows a front elevation and a cross section view of the filtering element assembly that does not come apart or disintegrate when used with lubricant oils or fuels.

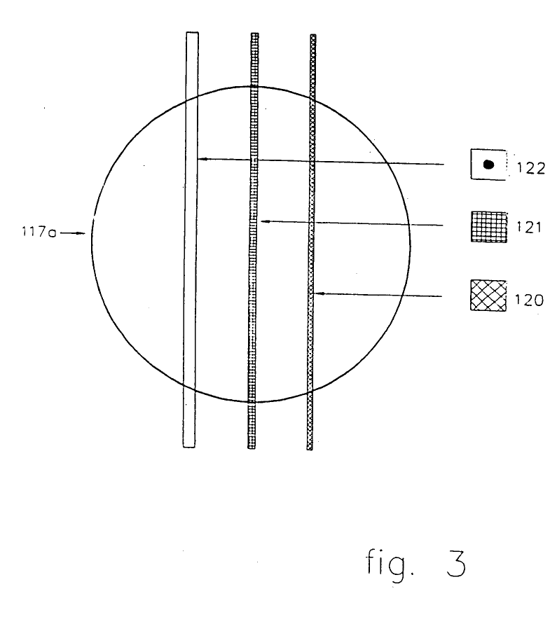

FIG. 3 Shows a general view of the detail shown in FIGS. 1 and 2.

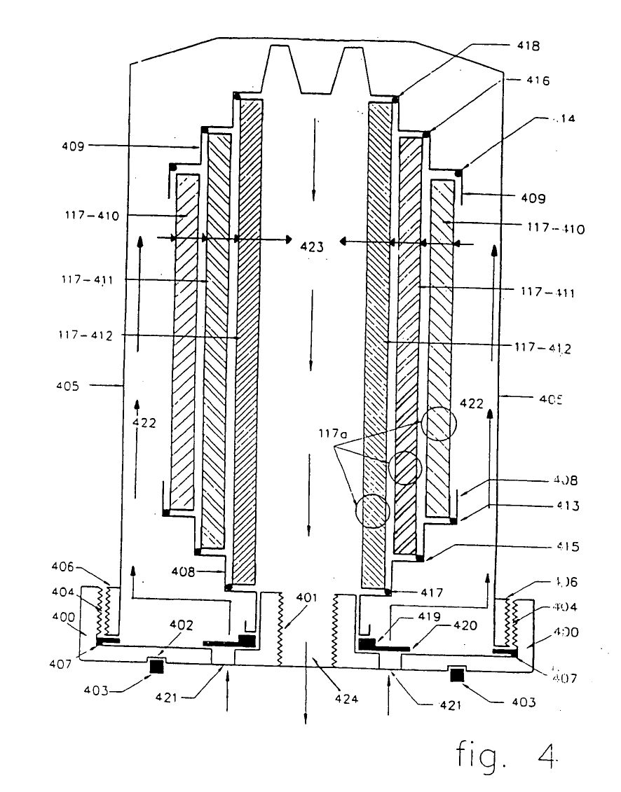

FIG. 4 shows a front elevation and cross section view of another arrangement of an ecological, washable non-disposable filter for lubricant oils and fuels.

In reference to this, FIG. I shows an arrangement of an ecological washable non-disposable filter for lubricant oils and fuels to be used in internal combustion engines or in any other equipment as per the present invention, formed by the combination of the body (100) that is kept in working position by the fluid derivation cap (101) and cap (102), this caps press the body (100) placed between them using the screws (103) and nuts (104) and in order to prevent leaks at the union of the body (100) and the caps (101) and (102) the gaskets (105) and (106) are used. The bypass cap (101.) has a port of entry (107) that feeds the impeller turbine (108). When the fluids go through the vanes (109) a centrifugal action is generated and the fluids are projected against the interior vessel wall (110) separating this way the water contained in some fluids as diesel as well as the bigger pollutant particles and settling them down to the vessel's bottom (110) discharging them out through the draining cock (111); the semi-clean fluid free of water and major particles goes through the slots (113) of the diffuser cone (112) going then to the distribution chamber (116) so when it becomes filled with the semi-clean waterless fluid it can go through the filtering element (117) that in this arrangement is alone but there can be several of this elements working together. This filtering element (117) do not come apart o [symbol] disintegrate and is arranged as shown in the detailed view (117^{a}) where the open mesh (120) acts as a front support for the fine filtering stainless steel fabric (121) that works retaining the big, medium and small impurities depending on the gage of each fine filtering fabric. In order to hold the fine filtering fabric (121) in working position, rods (122) are used to form a cage in the back that do not reduce the area or filtering capacity and do prevent the deformation or disarrangement of the fine filtering fabric (121) while performing the cleaning or back-flushing. Once the already clean fluid has gone through the filtering element (117) it fills the exit chamber (118) and goes outside trough porthole (119). The rods (122) forming the cage that holds the fine filtering fabric (121) in position, goes from the upper cap (123) to the lower cap (124) of the filtering element (117), the rods (122) are secured to the caps (123) and (124) together with the open mesh (120) and the fine filtering stainless steel cloth (121) using an special resin to hold then together in one piece filtering element (117) free of leaks and easily washable without any deformations or disintegration so there is no need to throw it to the waste eliminating this way the pollution. The gasket (126) is used to avoid leaks between the upper cap (123) of the filtering element (117) and the slot (125) of the upper cap (102), and gasket (128) is used to avoid leak between the filtering element (117) and slot (127) of the by pass cap (101). The filter comprises a particle removing disc assembly (200), this assembly includes the shaft (201) and discs (202) that are pushed down from the outside operating the knob (203) that is repositioned by the action of spring (204). There is a fluid turbulence generated by the repetition of this movement several times up and down together with the friction of bristles (202^{a}), this turbulence and friction of the bristles removes the dirt particles that are trapped in the fine filtering stainless steel fabric (121) and this particles fall and go trough the slots (113) in the diffuser cone (112) and the turbine (108) settling down in the deposit (110) from where they will be discharged to the exterior together with water trough the venting cock (111).

The gasket (205) is used to avoid leaks between cap (102) and the shaft (201), and gasket (206) is used to prevent leakages between vessel (110) and the bypass cap (101).

FIG. 2 shows an expanded view in front elevation and cross section of an assembly of the filtering element (117) that includes the open mesh front support (120) that gives support to the fine filtering stainless steel fabric (121) that is kept in working position using rods (122) that form a cage in the back that prevents the deformation and collapse of the fines filtering fabric keeping it in its working position even while performing the cleaning procedure, rods (122) go from the upper cap (123) to the lower cap (124), this special caps work as a support of all the parts that are included in the filtering element (117) assembled using a resin (124^{a}) to form the one piece filtering element (117) free of leaks.

FIG. 3 shows an expanded view of the detail (117^{a}) shown in FIGS. 1 and 2 where the open mesh (120) can be seen, as well as the fine stainless steel filtering fabric (121) and rods (122).

FIG. 4 shows another preferred arrangement that includes the cap fitting (400) that is screwed to an internal combustion engine or other device using the thread (401), the cap fitting (400) has a slot (402) in which the gasket (403) is inserted forming a seal against the motor to prevent leaks, the cap fitting (400) is threaded (404), by this thread the cup shaped body housing (405) is secured using thread (406), gasket (407) is used to prevent leaks between the cup shaped body housing (405) and the cap fitting (400). Inside the cup shaped body housing (405) there is a base designed in steps (408) and stepped cap (409). The assemblies of filtering elements (117- 410), (117-411) and (117-412) are inserted here, having the same construction as the filtering element assembly (117) in FIGS. 1,2 and 3 where each of them has a back open support, a fine filtering stainless steel fabric (121) of a different gage a needed according to the particles size to be filtered, starting with the largest and going down to the smaller ones, and rods cage support in the front.

The gaskets (413) and (414) are used to prevent leaks between the filtering element (117-410) and the stepped base (408) and the stepped cap (409), gaskets (415) and (416) are used to prevent leaks between the filtering element (117-411) and the stepped base (408) and the stepped cap (409), gaskets (417) and (418) are used to prevent leaks between the filtering element (117-412) and the stepped base (408) and the stepped cap (409), the special gasket (419) is used to prevent leaks between the cap fitting (400) and the stepped base (408),the special gasket (419) is pushed in the edge(420) by the pressure exerted by the flow going trough the holes (421). When the chamber (422) is filled by the still dirty fluid, this goes trough the filtering element (117-410) filtering the large sized particles and then goes trough filtering element (117-411) filtering the medium sized particles and finally goes trough the filtering element (117-412) filtering the smallest size particles. All the particles are retained according to their size and the gage of the fine filtering stainless steel fabric; once filtered and free of impurities the fluid fills chamber (423) and through port (424) enters again the motor or other device.

As it has been stated for explanation, but without limitation, the designed parts and their function in the assembly of a washable, non-disposable, ecological filter for lubricating oils and fuels to be used in internal combustion engines or in other equipment, has been described in the contents of the present invention.

The many possible modifications, substitutions and additions will be evident to the experts, always without modifications of the scope of the novelty, the functioning and results of the present invention.

Having described with sufficient detail my invention, I consider it as a novelty and thus I claim it of my exclusive property what is stated in the following claims:

1. A reusable, ecological, long lasting, washable, and non disposable filter for lubricant oils and fuels to be used in internal combustion engines or in any other equipment, which comprises:
(a). A cylindrical housing having two end cap fittings, the liquid to be filtered enter the inner cavity formed by the filter assembly and flow through to the annular chamber:
(b) one or several essentiality cylindrical independent filter assemblies placed one inside the other, each filter assembly consisting of:
(bi) a fine filtering stainless steel cloth
(bii) enclosed in, and retained in the front by an open mesh and
(biii) retained by a number of rods extending longitudinally between the two end caps and forming a cage in the interior of the fine filtering stainless steel cloth
(biv) the three concentrically positioned elements (bi-iii) being joint to form an assembly of a single unit by resin caps at each end, thus forming a seal. Each independent filtering assembly use a different mesh according to the size particles to be filtered.
(c) the filter comprises a particle removing disc assembly
(ci) one or several discs fastened to a concentric shaft extending longitudinally between the two end caps;
(cii) said discs comprising bristles at their periphery which are in contact with the rods and the fine filtering stainless steel cloth of the inner filtering element
(ciii)said shaft being rotatable and can be operated from the outside of the filter when cleaning is needed.
(d) the filter comprises the use of all the necessary gaskets to avoid leaks between the parts.

2. The filter described in claim 1 wherein the independent filtering assemblies can be used directly in the two end caps, or in a stepped on flat base and cap.

3. The filter described in claim 1 wherein the cylindrical independent filter assemblies placed one inside the other can be separated easily to be washed and cleaned free of the need to discard them when they become saturated whit impurities.

4. The filter described in claim 1 wherein the cylindrical independents filtering assemblies have the fine stainless steel cloth of a different mesh following the flow direction, the first element retains the larger particles the second element retains medium sized particles and the third element retains the smaller ones.

5. The filter described in claim 1 wherein by changing the flow direction of the fluid to be filtered to enter the annular chamber and flowing through the filtering assemblies to the inner cavity, the filtering assemblies have to be changed. The fine filtering stainless steel cloth is retained in the interior by an open mesh and also is retained in the front by a rods cage.
